(19) United States
(12) Patent Application Publication
(10) Pub. No.: US 2024/0240661 A1
(43) Pub. Date: Jul. 18, 2024

(54) TWO-STEP LOCKING CONNECTOR

(71) Applicant: FYX BV, Sint-Niklaas (BE)

(72) Inventors: Jeroen DE SMET, Belsele (BE); Ivan PEETERS, Beveren-Waas (BE); Koen DE SMET, Knokke-Heist (BE)

(73) Assignee: FYX BV, Sint-Niklaas (BE)

(21) Appl. No.: 18/000,524

(22) PCT Filed: Mar. 24, 2022
(86) PCT No.: PCT/EP2022/057850

§ 371 Date: Dec. 2, 2022

(51) Int. Cl. F16B 21/16; F16B 7/04

(52) U.S. Cl. CPC F16B 21/16; F16B 7/042

(57) ABSTRACT

The present invention concerns a locking connector that makes it possible to connect different elements together in a two-step way. When connecting the two elements, in the first step, one element will be attached and blocked via a part to the second element and locked in the second step. As a result, the housing elements are connected in a secure manner and can no longer be disconnected from each other without additional action by the user.

### INTRODUCTION

The present invention concerns a locking connector that makes it possible to connect different elements together in a two-step way. When connecting the two elements, in the first step one element will be attached and blocked, via a part to the second element and locked in the second step. As a result, the housing elements are connected in a secure manner and can no longer be disconnected from each other without additional action by the user.

### STATE OF THE ART

There are already many well-known techniques described in the patents and in commercial execution in which different elements, such as profiles or furniture walls, can be connected to each other, whether or not via a quick coupling.

The most well-known and still very often used connection is the screw connection, in which the different elements are connected to each other.

But other forms of coupling are also frequently used.

An example of a recent patent describing a shortcut is the patent with publication number US2003089674 A1.

This invention describes a profile-section support system, which is in particular used for industrial fair and exhibition construction, with hollow profile-section supports of polygonal cross-section, having at least one outer side with edges provided with ribs defining grooves with peripheral undercuts therebetween, comprising additional parts selected from the group consisting of further profile-section supports and other parts, and further comprising connecting elements anchored in said undercuts and connecting said additional parts, said connecting elements having corner regions with inner corner grooves, thereby allowing a spreading apart of the ribs with deformation of the at least one outer side wherein ribs are disposed on the at least one outer side adjoining the hollow profile-section supports, and wherein two ribs on an edge between adjacent outer sides of the hollow profile-section supports define an outer corner groove.

Nearly all of the well-known coupling techniques described in the patents describe techniques specific to a particular application.

In addition, no techniques have been described in the patents that combine a blocking mechanism, which performs the function of recoil mechanism, and a clamping system that can put the locking mechanism under tension, as an extra safety. The problem with the shortcuts that can be applied multidisciplinary to put different elements together is that they only have a single protection. If the clamping mechanism comes loose, the connection is not or hardly secured.

Also, nowhere are the locking mechanism and the clamping mechanism used as a two-step technique so that no two-step protection device is provided.

### SUMMARY

The present invention and versions thereof serve to provide a solution to one or more of the above-mentioned disadvantages. To this end, the present invention relates to connectors and processes as described in the claims and further below.

In a first aspect, the present invention relates to a connector consisting of at least one first connector and a second connector, comprising a longitudinally extending assembling pin, comprising at least one pin retention means on the mantle of the assembling pin;
said second connector comprising a housing with a longitudinal cavity dimensioned to receive the assembling pin of the first connector via an axial opening of the housing, said second connector comprising a blocking means, positioned in the housing radially movable between a first position and a second position, wherein the blocking means is mounted biasedly to the first position, whereby in said first position a retention protrusion of the blocking means extends into the cavity into the path of the pin retention means along the longitudinal axis of the cavity when the assembling pin is in the cavity, thereby preventing removal of the assembling pin when the pin retention means is past the retention protrusion of the blocking means;
whereby in said second position, the blocking means does not extend into the path of the pin retention means along the longitudinal axis of the cavity when the assembling pin is in the cavity;
the second connector further comprising a locking means, hingedly connected to the housing, said locking means being hingedly movable between a first state and a second state, wherein the locking means when in the first state is positioned to lock the blocking means into the first position, wherein the locking means when in the second state is positioned to allow movement of the blocking means out of the first position;
and wherein the pin retention means and the retention protrusion are configured to move the blocking means from the first position at least partially towards the second position while the pin retention means move past the retention protrusion during insertion of the assembly pin into the cavity when the locking means is not in the first state.

In a second aspect, the blocking means can also be positioned in a different place than in the housing of the connector, where the function of the blocking means still remains the same. An alternative place for the blocking means may be in the assembling pin. This can be done via, but not limited to, a version of a hinge element.

According to a preferred output form, the assembling pin is provided with retention means where it has an oblique side that has a continuously declining radius from the longitudinal axis of the assembling pin towards the distal end of the assembling pin.

In addition, the assembling pin with retention means may have different shapes depending on the shape of the pin. For example, the retention means can comprise a single protrusion but also multiple protrusions that may or may not be arranged at an even distance. In a version where the assembling pin does not have a round shape but, for example, has a flattened one such that it fits in the cavity only under a certain orientation (or a discrete number of orientations), the retention means can be a straightening protrusion. The retention means is preferably of the barb principle. This allows the assembling pin to be easily inserted into the housing but at the same time it is blocked from removal back because the retention means remains stuck behind the blocking protrusion of the blocking means. The assembling pin can be duplicated, making it possible to connect two different connectors if they are equipped with a connector where the assembling pin can be clamped.

The shape of the assembling pin can in longitudinal direction be round, flat, oval, rectangular or any other shape that is necessary according to the desired application and needs. Also, the combination of the retention means and blocking protrusion can have different forms as long as they hook together sufficiently strongly.

According to a preferred version form, the assembling pin has a semicircular cross-section, where the retention means is provided on the flat part of the assembling pin and is arranged transversely. As a result, the combination of the blocking means and the locking means can be provided in the hollow space so that the composite part that forms the connector is integrated into a tube.

The connector can also be used as an electrical connector according to an additional embodiment. The connected elements are also electrically connected, and where the electrical wires are preferably incorporated into the elements, such as a flexible tube.

According to a preferred design, the end of the assembling pin is provided with at least one electrical contact. On another protruding part of the pin, there is also at least one electrical contact. When installing the assembling pin in the housing, the electrical contacts provided on the assembling pin make contact with the electrical contacts of the connecting element that is fixed in relation to the housing. The electrical contacts are put under pressure by applying a certain tension to the retention means and therefore also to the assembling pin with the locking means. This method enables a safe electrical connection.

According to an additional embodiment, the connector can also be used as a pneumatic and/or hydraulic connector.

According to a preferred design, at least one seal is provided at the end of the assembling pin. When applying the hollow assembling pin in the housing, the end of the hollow assembling pin presses against the seal. The seal is arranged between the hollow assembling pin and the element to be connected, such as a flexible tube. This element, such as a flexible tube, is preferably arranged according to a fixed connection to the housing. By applying a certain tension to the retention means with the locking means and therefore also to the hollow assembling pin, the seal is put under pressure so that an airtight connection can be obtained between the hollow assembling pin and flexible tube.

Another possible embodiment is the connection of two profiles. By applying a connector on each profile, they can be connected on the front side by, for example, applying a double assembling pin where they are connected in a longitudinal direction but in the opposite direction. The two assembling pins can be loosely or rigidly connected. An assembling pin is blocked for each profile so that the adjacent profiles are extended against each other in a longitudinal direction. When setting up the profile in, for example, a frame arrangement, it may be important that the profiles are adjustable in length. To achieve this, one can use extension parts. This makes the use of an extended assembling pin necessary. In the case of a setup in an extended profile, the extended assembling pin can be applied to compensate for the difference in length and still apply the operation of the combination blocking means and locking means to the extended assembling pin.

The direction of the force vectors that the blocking means exerts on the assembling pin can be longitudinal, lateral, transverse, whether or not at a certain angle, or a combination of two or more of the directions indicated above. This is according to the embodiment and the desired result.

For versions where large forces have to be absorbed, it is preferable to use metal-based materials, but for lighter versions, plastics can be used. A mix of metal and plastic, as well as other materials, is possible.

### DESCRIPTION OF THE FIGURES

The following description of the figures of some specific embodiments of the invention is more exemplary in nature and is not intended to describe current teachings, their application or use. In the drawings, corresponding reference numbers indicate similar or corresponding parts and characteristics.

FIG. 1*: a representation of the connector in perspective of a cross-sectional corner unit for hanging furniture where the locking means is set up in a closed state

FIG. 2*: a representation of the connector in perspective of a cross-sectional corner arrangement for hanging furniture where the locking means is set up in an open state

FIG. 3*: a representation of the connector in perspective of a cross-sectional corner unit for hanging furniture where the locking means is set up in a blocked state

FIG. 4*: a representation of the connector in perspective of a corner unit for hanging furniture in which the locking means is set up in a closed state

FIG. 5*: an exploded representation in perspective of a corner unit for hanging furniture in which the locking means is set up in a closed state

FIG. 6*: a representation of the connector in perspective of a tube arrangement in cross-section where the locking means is set up in a closed state

FIG. 7*: a representation of the connector in perspective of a pipe arrangement in which the assembling pin has not yet been installed in the housing and both the blocking means and the locking means are set up in an open state.

FIG. 8*: a representation of the connector in perspective of a pipe arrangement in which the assembling pin is placed in the housing and both the blocking means and the locking means are positioned in a closed state.

FIG. 9*: a representation of the connector in perspective of a profile arrangement in cross-section where the locking means is arranged in a closed state. The profile is equipped with some extension parts and an extended assembling pin.

FIG. 10*: a representation of the connector in perspective of a profile arrangement in which the locking means is set up in a closed state. The profile is equipped with some extension parts and an extended assembling pin.

FIG. 11*: a representation of the connector in perspective of a tube arrangement in cross-section in which the assembling pin with electric wires is placed in the housing and both the blocking means and the locking means are arranged in a closed state. The connector is equipped with electrical contacts and electrical wires to form an electrical coupling.

FIG. 12*: a representation of the connector in perspective of a tube arrangement in cross-section in which the assembling pin with electric wires is positioned outside the housing and both the blocking means and the locking means are positioned in a closed state. The connector is equipped with electrical contacts and electrical wires to form an electrical coupling.

FIG. 13*: a representation of the connector in perspective of a hinge element in cross-section where the locking means is arranged in a closed state.

FIG. 14*: a representation of the connector in perspective of a hinge element in cross-section where the locking means is arranged in an open state.

FIG. 15*: a representation of the connector in perspective of a hinge element in cross-section where the locking means is arranged in an open state and the assembling pin is positioned outside the housing.

FIG. 16*: a representation of the connector in perspective of a hinge element in cross-section where the locking means is set up in a blocked state.

FIG. 17*: a representation of the connector in perspective of a hinge element in which the locking means is arranged in a closed state.

FIG. 18*: a representation of the connector in perspective of a tube arrangement in cross-section with a hollow assembling pin and seal, where the locking means is arranged in a closed state

FIG. 19*: a representation of the connector in perspective of a door hinge in which the assembling pin of the hinge is positioned outside the housing.

FIG. 20*: a representation of the connector in perspective of a tube arrangement in cross-section with a lock.

### ENUMERATION OF THE PARTS IN THE FIGURES

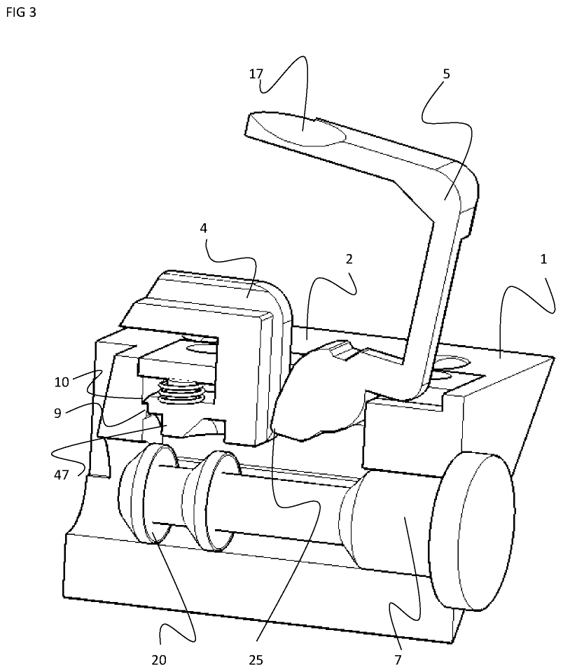

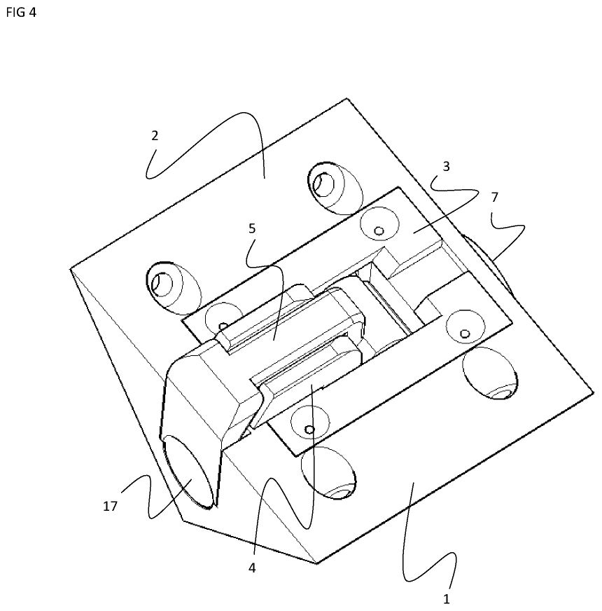

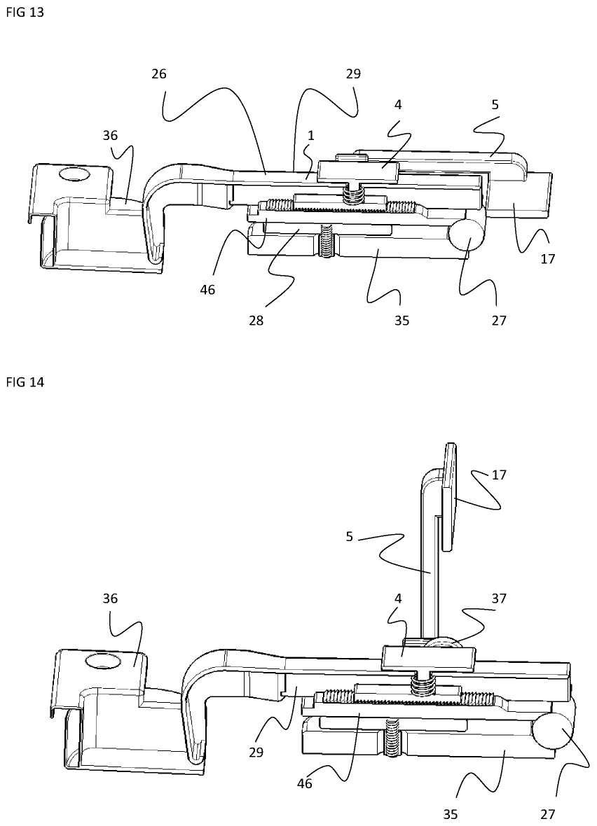

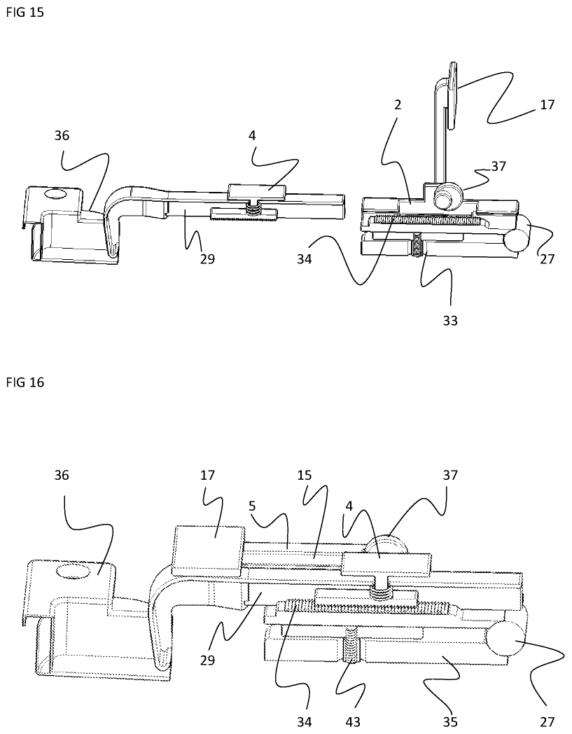

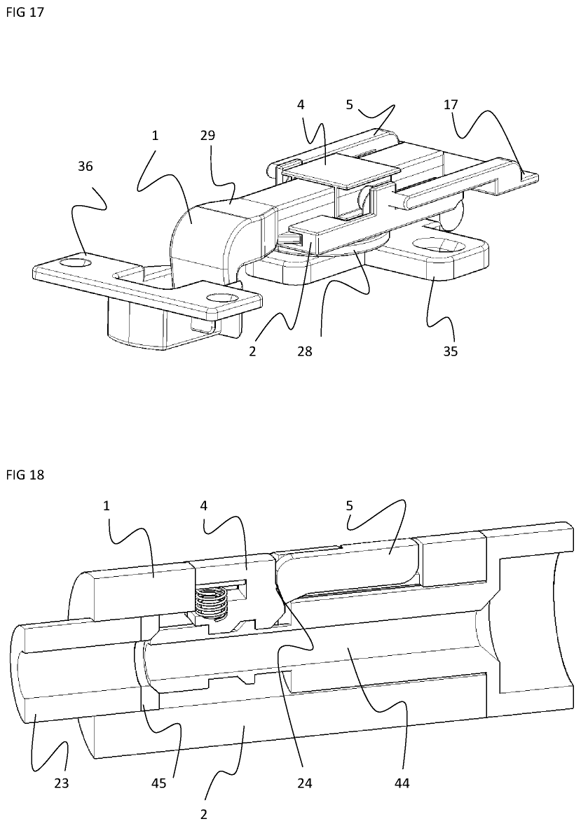

1. Connector: it comprises four basic parts, which are the housing, blocking means, locking means, and assembling pin.
2. Housing: this can be in different versions, such as a tube shape, an angled shape, for example, for hanging furniture.
3. Cover: this blocks the hinge of the locking means and ensures the clamping of the spring at the blocking means.
4. Blocking means: blocking the assembling pin.
5. Locking means: exerts pressure on the blocking means.
6. Spring: causes the blocking means pressures on the assembling pin.
7. Assembling pin: is the pin that is blocked by the blocking means and is the connection to the linked element. It can also be mirrored, for example, when connecting two profiles.
8. Spring centering means: keeping the spring in place.
9. Positioning recess: this part rests on the positioning protrusion when the connector is blocked in an open position. The connector is in a blocked open position when the blocking means is secured in such a way that the assembling pin can move freely.
10. Positioning protrusion: the rest positioning recess when the connector is blocked in an open position.
11. Electrical contacts: these are the contact points that provide the electrical connection between the assembling pin and the housing.
12. Profile: these are profiles such as aluminum profiles that are provided with ribs in which the blocking and locking means are incorporated.
13. Extension parts: these are intermediate parts for the profile that can extend the profile if the extended assembling pin is used.
14. Hinge: this ensures that the locking means can rotate in the housing.
15. Lever: this is the lever of the locking means.
16. Axial opening: this is the opening in the housing in which the assembling pin fits.
17. Handle of the locking means: handle for operating the locking means.
18. Aperture: the gap between the ribs of the profiles.
19. Ribs: the ribs of the profile that, among other things, form the gap.
20. Retention means: protrusions of the assembling pin.
21. Extended assembling pin: this is an extended version of the assembling pin that is equipped with multiple retention means.
22. Rotational blocking means: this is the pin to keep the assembling pin in place against rotating the profiles.
23. Flexible tube: this is a flexible tube that is clamped in the housing and where it connects to the hollow assembling pin via the seal.
24. Protrusion blocking means: this blocks the blocking means when the locking means is in a closed position. The protrusion pushes against the blocking means so that it can no longer move upwards and also puts tension on the assembling pin via the blocking means.
25. Protrusion jamming means: blocks the blocking means when the connector is in an open position. In other words, the moment the positioning protrusion rests on the positioning recess, the protrusion jamming means ensure that this position is maintained. This is shown in FIG. 3. To keep the locking means in this position, we have to create some kind of resistance (at the hinge or elsewhere) where the locking means can remain in this position.
26. Hinge element: hinge element for, for example, doors of cabinets; this is the general name for the entire hinge element.
27. Adjustment hinge: the hinge that connects the hinge base to the functional base.
28. Adjustment wheel: this to adjust the angle of the hinge to align the doors of the cabinets. It also forms a connection between the hinge base and the functional base.
29. Hinge pin: this fulfills the same function in the hinge element as the assembling pin.
30. Electrical wires: are incorporated in the mantle and are connected to the electrical contacts.
31. Mantle: can be a flexible tube but also a solid tube, for example, a post of a carport in which electrical wires are provided.
32. Assembling pin with electric wires.
33. Threaded nut: this is rotatably arranged, and in this, the threaded bolt moves when the adjustment wheel is turned so that the hung base and the functional base move closer or further apart.
34. Toothed rail: is part of the functional base. The teeth of the blocking means engage the teeth of the toothed rail. The teeth are made according to the barb principle, which means that the hinge pin can be applied without manipulating the locking means but cannot be extended without lifting the blocking means.
35. Hinge base: this is the basic element of the hinge element and is fixed in the wall of the cabinet.
36. Door base: this is the part of the hinge element that is fixed in the door of the cabinet.
37. Push part: this locks the blocking means and adjustment wheel in closed position FIG. 13-17, in open position as shown in FIGS. 14 and 15 where the locking means in a 90-degree position allows the hinge pin to retract, in a fully extended position as shown in FIG. 16, the blocking means is held upwards, and the hinge pin can be moved freely without manual manipulation.
38. Lock: the locking means can be blocked by means of a lock on the housing.
39. Eye: this part fits into the lock allowing the locking means to be locked.
40. Door hinge: hinge element that can be used to fix a door in a casing.
41. Hinge plate: the assembly pins are mounted on this.
42. Door hinge axis: the axis that forms the connection between the hinge plates.
43. Threaded bolt: this is permanently mounted on the adjustment wheel.
44. Hollow assembling pin: this is a hollow version of the assembling pin.
45. Seal: is a seal between the hollow assembling pin and the flexible tube.
46. Functional base: this is the part of the hinge element where the blocking techniques are provided.
47. Blocking protrusion: these are the protrusions of the blocking means that grab behind the retention means of the assembling pin.

### Advantages

The present invention is primarily a competitor for existing single quick couplings. Compared to this type of coupling, it has some specific advantages. The whole is composed of a limited number of pieces, it can be used multidisciplinary, it can be made in metal and/or plastics and it is straightforward to use. It has double protection and a recoil device combined with a clamping system in a unique way.

The intrinsic composition of the technique makes it multidisciplinary.

Possible areas of application without being limited to these areas of application:
Hanging device for hanging furniture
Interconnecting profiles or tubes in general
Tent poles and other types of rods
Poles of parasols, possibly equipped with an internal electrical connection
Hanging system for curtains
Fixing table legs or other supports
Hinges for doors and cabinets
Quick couplings for water and pressure pipes
Frames such as for swimming pools, formwork, stand construction, etc
Hanging systems for TV and related products
etc

### DETAILED DESCRIPTION OF THE INVENTION

The present invention relates to a composite connector built around four basic elements, i.e., an assembling pin, a blocking means, a locking means and a housing. The present invention also relates to connectors for said assemblies and methods for constructing a two-step locking connector.

Unless otherwise defined, all terms used in revealing the invention, including technical and scientific terms, have the meaning as generally understood by one skilled in the art for the field to which this invention belongs. Through further guidance, term definitions have been included to better appreciate the teachings of the present invention.

As used herein, the following terms have the following meanings:

“Over” as used herein, referring to a measurable value such as a parameter, an amount, a duration and the like, is intended to allow variations of +/−20% or less, preferably +/−10% or less, rather +/−5% or less, even more preferably +/−1% or less, and with even more preference +/−0.1% or less of the specified value, to the extent that such variations are suitable to perform in the revealed invention. However, it should be clear that the value to which the modifier refers “approximately” is itself also specifically stated. “Provided and “includes” and “consisting of” as used herein are synonymous with “include”, “including”, “includes” or “contain”, “containing”, “contains” and are inclusive or open terms that specify the presence of what follows, for example, a component, and exclude the presence of additional, unrecited components, characteristics, connectors, members, steps, known in the technique or revealed therein.

Furthermore, the terms first, second, third, and the like in the description and in the claims are used to distinguish between similar connectors and are not necessary for describing a sequential or chronological order unless otherwise indicated. It is understandable that the terms thus used are interchangeable under the right circumstances and that the embodiments of the invention described herein may be in sequences other than those described or illustrated herein.

The recitation of numerical ranges by endpoints includes all numbers and fractions housed within that range, as well as the endpoints mentioned.

While the terms ‘one or more’ or ‘at least one’, such as one or more or at least one member(s) of a group of members, is necessarily clear, by further example, the term includes a reference to one of the said members, or to two or more of the said members, such as, for example, ≥3, ≥4, ≥5, ≥6 or ≥7 etc. of said members, and to all said members.

All references cited in this specification are hereby incorporated in their entirety by reference. In particular, the doctrine of all references specifically referred to herein is to be incorporated by reference.

Unless otherwise defined, all terms used in revealing the invention, including technical and scientific terms, have the meaning as generally understood by one skilled in the art for the field to which this invention belongs. Through further guidance, definitions for the terms used in the description are included in the teachings of the present invention. The terms or definitions used herein are given solely to assist in understanding the invention. Reference in this specification to “one embodiment” or “an embodiment” means that a particular feature, structure or feature described in connection with the embodiment is included in at least one embodiment of the present invention.

In this light, the appearances of the expressions “in one composition” or “in a composition” in different places in this specification do not necessarily all refer to the same version, but they can. In addition, the special features, structures or characteristics can be combined in any appropriate way, as would be clear to a professional from this description, in one or more embodiments.

In addition, although some embodiments described herein include some, but not all other features included in other versions, combinations of features of different versions are intended to fall within the scope of the invention and constitute various performances, as will be understood by the craftsman.

For example, in the following claims, any of the claimed embodiments can be used in any combination.

The terms “first connector” and “second connector” refer to two types of connectors, which can still be of the same type.

When using the x, y and z-axis as an indication, reference is made to an example, where the connector and therefore also the assembling pin is arranged horizontally and the blocking means and locking means are positioned above the assembling pin.

This refers to the x-direction as the longitudinal direction of the assembling pin, i.e., the direction in which the assembling pin is moved when applying the assembling pin in the housing. The y-direction represents the transverse direction in the horizontal plane relative to the x-direction and the z-axis is the transverse direction relative to the x-axis in the vertical plane.

When defining the components such as the blocking means, gradients can be used to determine the shape of the blocking protrusion according to the z-direction. This is preferably between 0 and 1°, but can also work with gradients between 1° and 3°, with possibilities up to 5° and depending on the implementation of combination recesses and protrusions of the pins the shape of the pins themselves or a combination of shapes and/or different materials of pins, the slope of the pins can be ≥5° and the gradients can even be negative.

General principle of operation.

The general principle of operation of the present invention is based on a two-step system. In the first step, the assembling pin is inserted and positioned in the housing where a blocking means blocks the assembling pin in such a way that it can no longer be removed from the housing without a deliberate, manual operation. In a second step, the assembling pin is indirectly put under tension via a locking means: the assembling pin is put under stress by the blocking means, whereby the blocking means is put under stress by the locking means.

To remove the assembling pin from the housing, the locking means must first be unlocked, after which the blocking means can be lifted and the assembling pin removed from the housing.

This results in the following modalities specific to the present invention's system. In the first step, the assembling pin is protected against the removal of the assembling pin from the housing. This can be compared to the operation of a non-return valve. In the second step, the extra security is the locking means. This must first be unlocked before the blocking means can be manipulated. This combination results in a double protection not present in other similar systems. In the event of an accidental detachment of the locking means, this does not automatically mean that the element connected to the assembling pin also automatically detaches from the element connected to the housing. After all, the assembling pin cannot come loose without the blocking means being lifted manually.

The technique described above results in an operation in which the assembling pin can be quickly and easily applied in the housing. In a second phase, the coupling of the elements to be connected can be put under the desired stress.

Below some embodiments are described, which are explained based on the figures.

The present invention describes a multidisciplinary technique and can therefore be applied in many different domains and be used for many different applications.

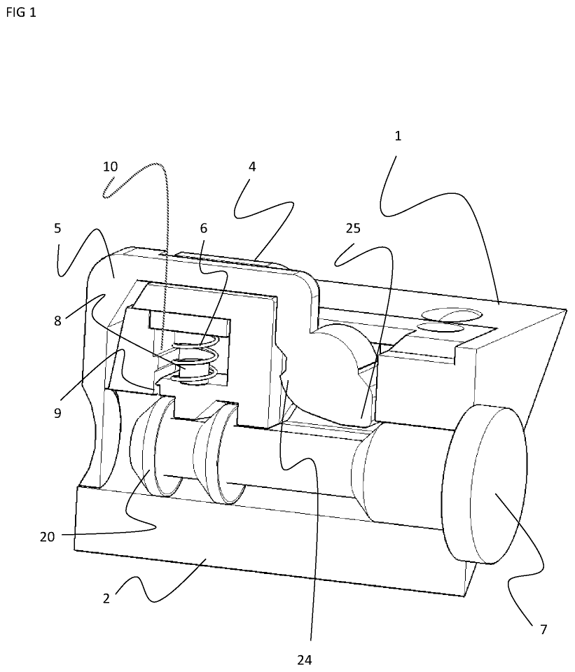

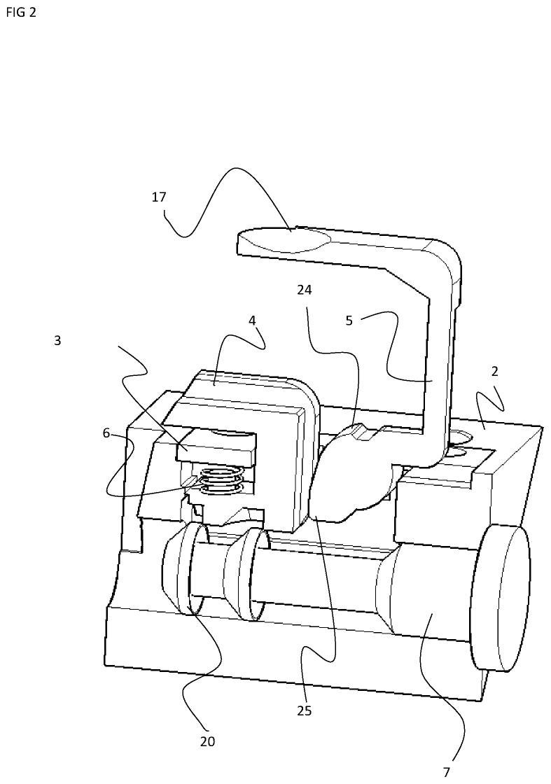

A possible application is the hanging of a piece of furniture. FIG. 1*-5* shows an angle version of a connector 1 that makes it possible to hang a piece of furniture. In this version, the housing 2 in the shape of a triangle is provided with openings to attach the housing 2 in the corner of the furniture with screws. In this version, the assembling pin 7 is attached to the wall in a direct or indirect manner. The housing 2 is mounted in the corner of the furniture to be hung with the axial opening 16 to the side of the back wall of the furniture. The back wall of the furniture itself is preferably also provided with an opening that has a diameter in which the assembling pin 7 fits smoothly. When using hanging furniture, it is preferable that at least two housings 2 are permanently mounted in the upper corners of the furniture and two assembling pins 7 mounted on the wall. Before the furniture is mounted on the wall, the locking means 5 is placed in an open position, as shown in FIGS. 2* and 4*, allowing the assembling pin 7 to be freely inserted into the housing 2. When inserting the assembling pin 7 in the x-direction in the housing 2, the retention means 20 pushes with the slanted side on the assembling pin 7 against the slanted side of the blocking means 4, moving them upwards in the z-direction. After passing the retention means 20 of the assembling pin 7, the blocking protrusion 47 of the blocking means 4 grab behind the retention means 20 of the assembling pin 7. As a result, the assembling pin 7 is blocked and can no longer be removed from the housing 2 without manually lifting the blocking means 4. In this position, the assembling pin 7 is blocked but not yet put under tension. To put the assembling pin 7 under tension, the locking means 5 must be placed in the closed position. The locking means 5 can be placed in a closed position, as shown in FIG. 1*, by turning the locking means 5 a quarter turn around its hinge 14, placing the lever 15 on the blocking means 4 and avoiding the blocking means 4 from moving away according to the z-direction from the assembling pin 7. As a result, the assembling pin 7 is double locked. In this position, the spring 6 provides a downward pressure of the blocking means 4 on the assembling pin 7. The spring 6 pushes along the bottom in z-direction against the blocking means 4 so that the blocking protrusion 47 of the blocking means 4 pushes against the assembling pin 7. When closing the locking means 5, the protrusion blocking means 24 pushes against the side of the blocking means 4, causing the blocking means 4 to exert pressure on the retention means 20 of the assembling pin 7 via the blocking protrusion 47. As a result, the assembling pin 7 is put under tension according to the x-direction. According to the x-direction, the contact point between the protrusion blocking means 24 and the blocking means 4 is lower than the axis of the hinge 14, so that the locking means 5 remains in place in a closed position. In the version as shown in FIG. 1*-5*, the locking means 5 is equipped with an extra handle of the locking means 17 that shields the opening in a closed position. The spring 6 pushes in the z-direction along the bottom on the blocking means 4 and the top on the 3. The cover 3 makes it possible for spring 6 to have a base in order to apply pressure to the blocking means 4 on the one hand, and for the combination of blocking means 4 and locking means 5 to be assembled in the production of the connector 1 on the other hand.

To remove the assembling pin 7 from the housing 2, the locking means 5 must first be positioned back into the open position by turning it a quarter turn as shown in FIG. 2*. In this position, there is enough space between the blocking means 4 and locking means 5 so that the blocking means 4 can move freely. This allows the blocking means 4 to be manually moved away from the assembling pin 7 according to the z-direction. This until the blocking protrusion 47 of the blocking means 4 is no longer in a position that it can block the retention means 20 of the assembling pin 7. Here, the spring 6 that is placed over a spring centering means 8 to hold the spring 6 in place, is compressed.

The basic principle is that the blocking means 4 is lifted manually to remove the assembling pin 7. However, if the connector 1 is used as a hanging system for a hanging cabinet, it is not easy to remove a cabinet from the pins of the wall and at the same time manually manipulate two blocking means 4. Therefore, an extra feature has been provided to make this operation easier. As shown in FIG. 3*, the blocking means 4 and the locking means 5 can be placed in a blocked position, making it possible to remove the assembling pin 7 without manually manipulating the blocking means 4 to remove the assembling pin 7.

Here the blocking means 4 is placed in an extreme position according to the z-direction where the spring 6 is compressed to the maximum and the 10 of the blocking means 4 rests on the positioning recess 9 of the housing 2. To keep the blocking means 4 in this position, the locking means 5 is placed in a blocked position, whereby the locking means 5 becomes more open than the open position shown in FIG. 2*. In the arrangement shown in FIG. 3*, the protrusion jamming means 25 of the locking means 5 pushes against the side of the blocking means 4, keeping the blocking means 4 in place in the blocked position.

In this blocked position, as shown in FIG. 3*, the blocking protrusion 47 of the blocking means 4 is no longer in the way of the retention means 20 of the assembling pin 7, allowing the assembling pin 7 to move freely. As a result, in a situation where the hanging furniture has to be removed from the wall, and therefore the assembling pin 7 from the housing 2, the blocking means 4 no longer has to be manipulated manually, and you can remove the furniture very quickly.

An additional difficulty that can occur when using connector 1 as a furniture suspension system is that the locking means 5 is not yet open when hanging the furniture. As a result, one would have to put the furniture back down and place the locking means 5 in an open position before wanting to place the furniture back over the assembling pin 7. To address such a situation, it is possible that the assembling pin 7 is applied in the 2, even if the locking means 5 is in a closed position. When moving the assembling pin 7 in x-direction where it is applied in the housing 2 and the locking means 5 is in a closed position, the oblique side of the retention means 20 of the assembling pin 7 pushes against the protrusion jamming means 25 of the 5. Since the locking means 5 is not tensioned, the locking means 5 will move to an open position when moving the assembling pin 7. This allows the assembling pin 7 to be installed in the housing 2 without first having to manually place the locking means 5 in an open position.

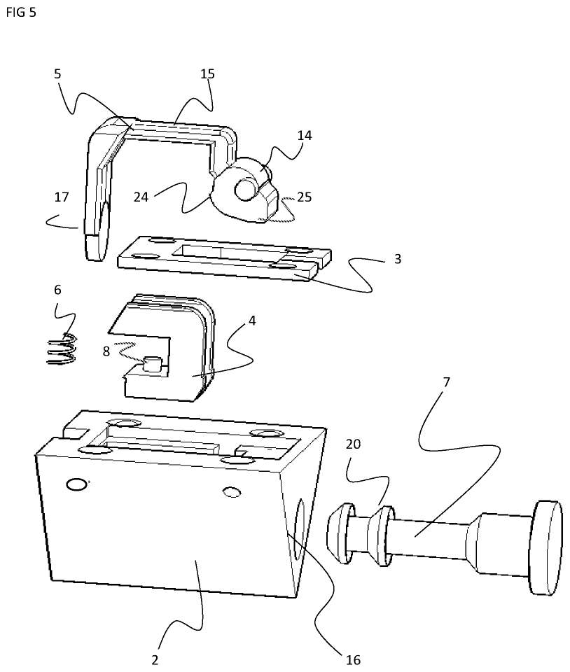

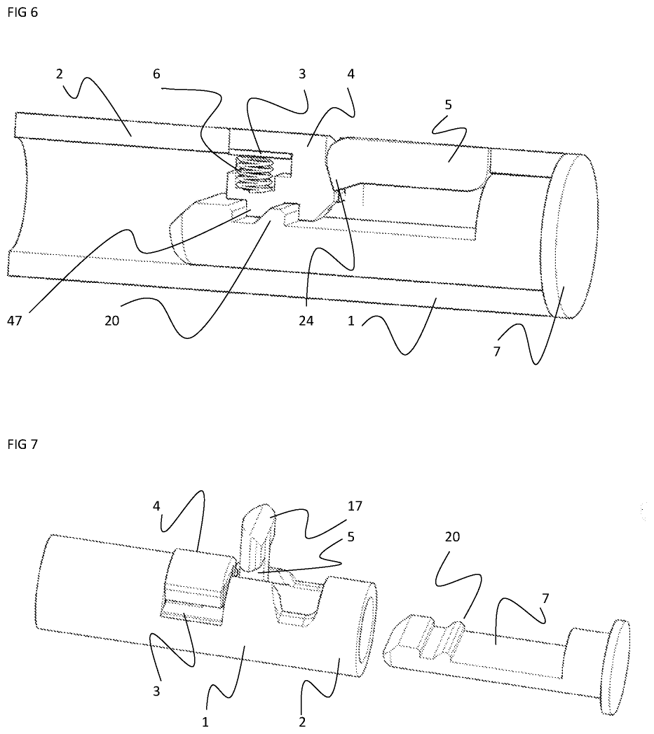

Another version is a version in which the housing 2 has the shape of a tube as shown in FIG. 6-8. In order to be able to operate the blocking means 4 and the locking means 5 in the tube itself, an assembling pin 7 with flattened shape is used. On the flattened part of the assembling pin 7, retention means 20 are provided. In FIG. 6*, a version of the connector 1 in a tube is shown in cross-section in which the retention means 20 of the assembling pin 7 is clamped inside of the tube by the blocking protrusion 47 of the blocking means 4 and put under tension by the protrusion blocking means 24 of the locking means 5 because the locking means 5 is in a closed position and the protrusion blocking means 24 of the locking means 5 presses against the side of the blocking means 4 so that the locking means 5 indirectly exerts pressure on the retention means 20 of the assembling pin 7 in x-direction. FIG. 7* shows an arrangement in which the assembling pin 7 is not mounted in the housing 2 and where both the blocking means 4 and the locking means 5 are in an open position. In this version, the locking means 5 is equipped with a handle of the locking means 17. Here too, the spring 6 is sandwiched according to the z-direction between the blocking means 4 on one side and the cover 3 on the other side. FIG. 8* shows an overview of the tube version showing that the blocking means 4 and locking means 5 are integrated into the design of the tube itself.

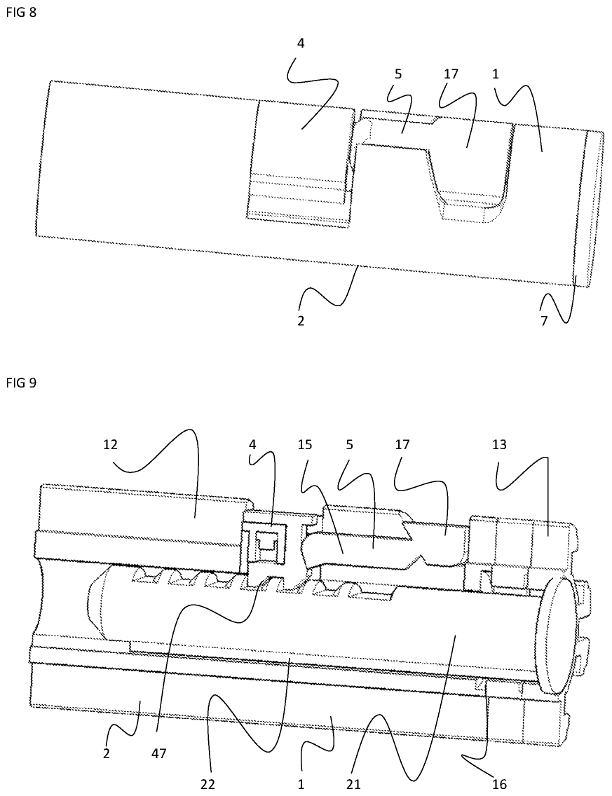

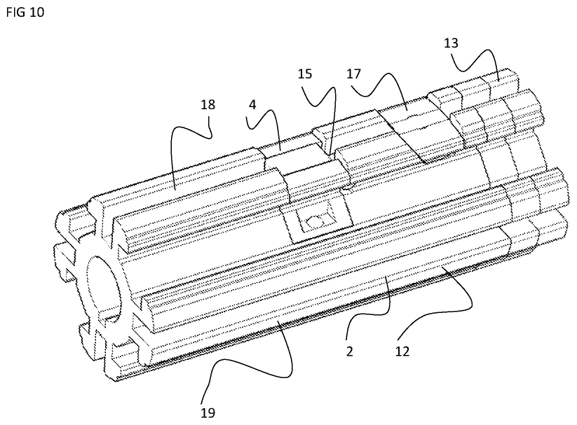

The connector 1 can also be used to connect, for example, profiles 12 with the end sides. As illustrated in FIGS. 9* and 10*, the connector can also be built into the end of a profile 12. The blocking means 4 and the locking means 5 are incorporated into the raised ribs 19, whereby the handle of the locking means 17 can conform to the shape of the ribs 19. In the version as shown in FIGS. 9* and 10* an extended assembling pin 21 is provided so that the 12 can be adjusted in length. By using the extension parts 13, the length of the profiles 12 itself can be adjusted, but then the assembling pin must also be adjusted, hence the use of an extended assembling pin 21. In FIGS. 9* and 10*, the locking means 5 is in a closed state, so that the extended assembling pin 21 is also put under tension. In these figures, a version is also shown in which the lever 15 of the locking means 5 can move between the ribs 19 and thus in the aperture 18 of the profile and is concealed in the closed state of the locking means 5.

The extended assembling pin 21 is equipped with multiple retention means 20 so that it can be clamped in different places. The user, therefore, has the possibility to use more or fewer extension parts 13, this of course within the limitations of the length of the extended assembling pin 21. In addition, the extended assembling pin 21 is also equipped with a rotational blocking means 22 that fits into a recess provided in the axial opening 16 according to the x-direction. This prevents the extended assembling pin 21 from rotating in the axial opening 16 and therefore also from turning the profiles 12 in relation to each other.

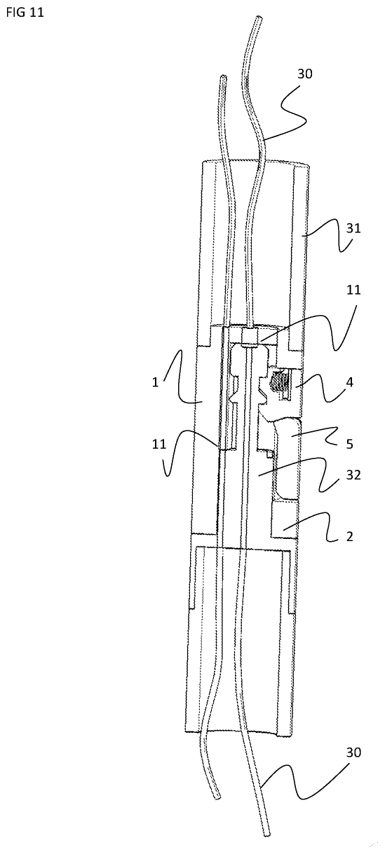

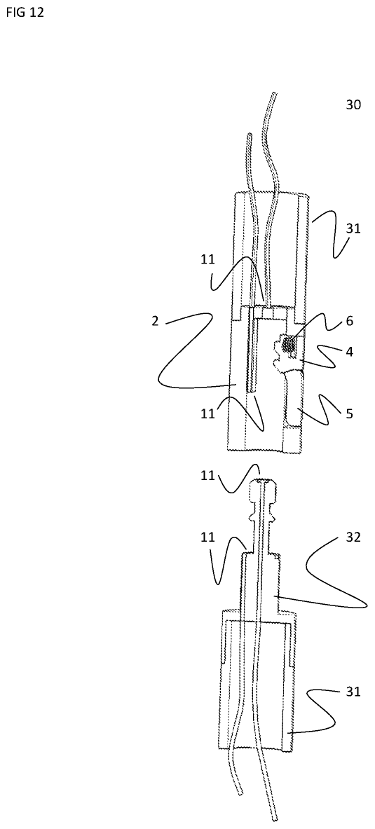

Another preferred form of execution is a connector 1 that also offers the possibility of making an electrical connection between two elements. As shown in FIGS. 11* and 12*, the pin is provided with a few electrical contacts 11 that are connected to electrical wires 30. The operation of the connector 1 is similar to the previous versions, but here the electrical contacts 11 are pressed together when the assembling pin with electric wires 32 is put under tension by the combination of the blocking means 4 and locking means 5. The electrical wires 30 preferably run internally in the mantle 31.

While it is shown in the embodiments as being connectable via two (or more) separate electrical contacts/electrical wires on both the housing and the pin, this can also be accomplished by a single, integrated contact on each end, for instance a concentric setup, to ensure that when the pin is in the housing and secured therein, there are two electrical pathways thusly created. This is particularly interesting in fixed-orientation connections, where the pin can only be secured in specific orientations relative to the housing, which guarantees proper alignment of the electrical contacts.

Another possible preferred form is a hinge element 26, as shown in FIGS. 13*-17*.

The operation is also similar to previous systems, but in this instance the blocking means 4 is not in the housing 2 but in the hinge pin 29. The blocking means 4 is equipped with teeth and presses via a spring 6 on a toothed rail 34, blocking it against the removal of the hinge pin 29. In order to remove the hinge pin 29, the blocking means 4 must be lifted manually. In FIG. 13* the locking means 5 is in a closed state where the push part 37 presses on the blocking means 4 and the blocking means 4 cannot be lifted so that the hinge pin 29 is blocked by the teeth of the blocking means 4 that engages the toothed rail 34. In FIG. 14* the locking means 5 is in an open position so that the blocking means 4 can be lifted and the hinge pin 29 can be removed. The hinge pin 29 does not exert pressure on the 4 in this position. In FIG. 16*, the locking means 5 is in a locked position where the push part 37 holds the blocking means 4 upwards. This allows the hinge pin 29 to move freely in and out.

The door base 36 is the part of the hinge element 26 that is mounted on the door and the hinge base 35 on the wall of the cabinet. To be able to adjust the door of the cabinet, an adjustment wheel 28 is used that can set the distance between the functional base 46 and hinge base 35 via a threated nut 33 and threaded bolt 43. The functional base 46, therefore, changes angles compared to hinge base 35 because it is arranged rotably around the adjustment hinge 27.

Another possible preferred version is shown in FIG. 18* where the connector 1 uses a hollow assembling pin. Between the hollow assembling pin 44 and the flexible tube 23, a seal is provided, creating an airtight connection between the hollow assembling pin 44 and the flexible tube 23. By closing the locking means 5, a pressure is applied to the hollow assembling pin 44 via the blocking means 4, which exerts a pressure on the seal. This creates a coupling for the passage of air or liquids.

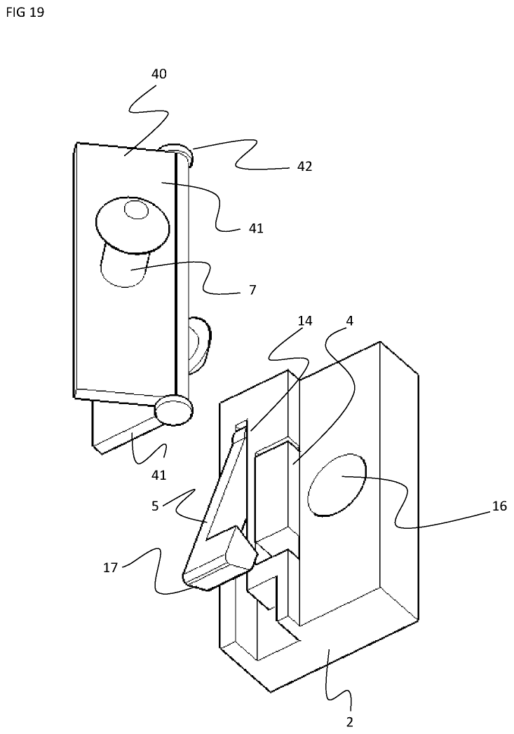

Another possible preferred version shape is shown in FIG. 19* where the connector 1 is used to hang doors. A housing 2 is provided in the casing of the door, and another housing 2 in the door itself. The assembling pin 7 is provided on the hinge plate 41 with the hinge 40. The two door blades 41 are connected by the door hinge axis 42. When placing the door, the assembling pin 7 is placed in the axial opening 16 with the blocking means 4 blocking the assembling pin 7. The locking means 5 then blocks the 4. To remove the assembling pin 7 from the axial opening 16, first, the locking means 5 must be opened, and then the blocking means 4 moved in the longitudinal direction to unlock the assembling pin 7.

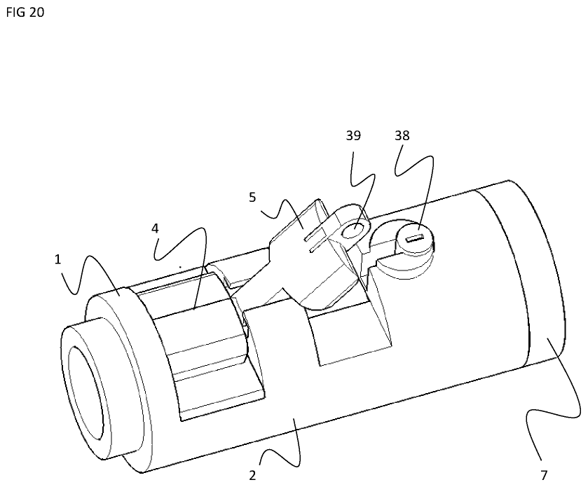

Another possible preferred version form is shown in FIG. 20*, where the connector 1 is supplemented with a lock 38. One possibility is that the locking means 5 is provided with an eye 39. This eye 39 fits in the lock 38 when closing the 5. When closing the lock 38, the eye 39 is locked in the lock 38, locking the assembling pin 7 in the 2. As long as the lock 38 is locked, the locking means 5 puts the blocking means 4 under tension, and the blocking means 4 cannot be moved.

1. Connecting device for detachably connecting a first element to a second element, comprising a first connector and a second connector;
said first connector comprising a longitudinally extending assembling pin, comprising at least one pin retention means on the mantle of the assembling pin;
said second connector comprising a housing with a longitudinal cavity dimensioned to receive the assembling pin of the first connector via an axial opening of the housing, said second connector comprising a blocking means, positioned in the housing radially movable between a first position and a second position, wherein the blocking means is mounted biasedly to the first position, whereby in said first position a retention protrusion of the blocking means extends into the cavity into the path of the pin retention means along the longitudinal axis of the cavity when the assembling pin is in the cavity, thereby preventing removal of the assembling pin when the pin retention means is past the retention protrusion of the blocking means;
whereby in said second position, the blocking means does not extend into the path of the pin retention means along the longitudinal axis of the cavity when the assembling pin is in the cavity;
the second connector further comprising a locking means, hingedly connected to the housing, said locking means being hingedly movable between a first state and a second state, wherein the locking means when in the first state is positioned to lock the blocking means into the first position, wherein the locking means when in the second state is positioned to allow movement of the blocking means out of the first position.

2. Connecting device, for detachably connecting a first element to a second element, comprising a first connector and a second connector;
said first connector comprising a longitudinally extending assembling pin;
said second connector comprising a housing with a longitudinal cavity dimensioned to receive the assembling pin of the first connector via an axial opening of the housing, said cavity comprising at least one pin retention means, said first connector comprising a blocking means, the blocking means positioned on the first connector radially movable between a first position and a second position, wherein the blocking means is mounted biasedly to the first position, whereby in said first position a retention protrusion of the blocking means extends into the cavity into the path of the pin retention means along the longitudinal axis of the assembling pin when the assembling pin is in the cavity, thereby preventing removal of the assembling pin when the retention protrusion of the blocking means is past the pin retention means;
whereby in said second position, the blocking means does not extend into the path of the pin retention means along the longitudinal axis of the assembling pin when the assembling pin is in the cavity;
the second connector further comprising a locking means, hingedly connected to the housing, said locking means being hingedly movable between a first state and a second state, wherein the locking means when in the first state is positioned to lock the blocking means into the first position, wherein the locking means when in the second state is positioned to allow movement of the blocking means out of the first position.

3. A connecting device according to claim 1, wherein said pin retention means has a continuously declining radius from the longitudinal axis of the assembling pin towards the distal end of the assembling pin.

4. A connecting device according to claim 1, wherein the retention protrusion comprises at least one continuously slanted side in the direction of the axial opening of the housing.

5. A connecting device according to claim 1, wherein said pin retention means has a continuously declining radius from the longitudinal axis of the assembling pin towards the distal end of the assembling pin, and wherein the retention protrusion comprises at least one continuously slanted side in the direction of the axial opening of the housing.

6. A connecting device according to claim 1, wherein the pin retention means comprise one or more wherein the axis of the segments align with the longitudinal axis of the assembling pin.

7. A connecting device according to claim 1, wherein the locking means comprises a hinge section with which the locking means is hingedly connected to the housing, and an L-shaped section which is connected with a first end to the hinge section, said L-shaped section comprising a proximal part and a distal part, which are substantially perpendicular to each other, wherein the proximal part abuts the blocking means in the first position when the locking means is in the first state.

8. A connecting device according to claim 7, wherein the housing comprises a recess for receiving the distal part of the locking means when the locking means is in the first state.

9. A connecting device according to claim 1, wherein the blocking means is biased against an internal surface of the housing by one or more springs.

10. A connecting device according to claim 1, wherein the longitudinal cavity and the assembling pin are dimensioned to receive the assembling pin in the longitudinal cavity via the axial opening under a single rotational orientation of the assembling pin with respect to the longitudinal axis of the longitudinal cavity.

11. A connecting Connecting-device according to claim 1, wherein the locking means comprises a protrusion extending away from the hinge axis around which the locking means hinges, wherein the protrusion is dimensioned to extend under the blocking means and catch said blocking means when in the first position during movement of the locking means from the first to the second state, thereby pushing the blocking means towards the second position.

12. A connecting device according to claim 1, wherein the housing comprises an internal positioning protrusion, and wherein the blocking means comprises a blocking protrusion, the locking means comprising a rotational body with variable radius, wherein when moving the locking means from the first to the second position, the variable radius of the rotational body towards the blocking means declines from a first radius in a first stage to a second radius in a second stage and then increases to a third radius in a third stage;
wherein in the first stage, the locking means pushes the blocking means so that the internal positioning protrusion and the blocking protrusion align radially, thereby preventing axial outward movement of the blocking means past a predefined point,
wherein in the second stage, the blocking means is provided with axial leeway to allow the internal positioning protrusion and the blocking protrusion to no longer align radially, thereby allowing axial outward and inward movement of the blocking means past the predefined point,
and wherein in the third stage, the locking means pushes the blocking means so that the internal positioning protrusion and the blocking protrusion align radially, thereby preventing axial inward movement of the blocking means past the predefined point.

13. A connecting device according to claim 1, wherein the blocking means comprises a recess along the longitudinal axis of the cavity, dimensioned to receive a portion of the locking means such that said received portion is fully sunk into the blocking means.

14. A connecting device according to claim 1, wherein the assembly pin is axially symmetrical and wherein the pin retention means comprises one or more frustoconical segments axially aligned with the assembling pin.

15. A connecting device according to claim 1, wherein the housing comprises a removable cover which comprises the internal surface of the housing against which the blocking means is biased with one or more springs.

16. A connecting device according to claim 1, wherein the assembling pin comprises a plurality of at least three or more pin retention means.

17. A connecting device according to claim 1, wherein the assembling pin is provided with one or more bare electrical conductor elements at its distal end,
and wherein the cavity of the housing is provided with one or more matching bare electrical conductors, positioned to align with and contact the electrical conductor elements of the assembling pin when positioned in the housing and locked therein, wherein electrical wires extend from said electrical conductor elements of the housing away from the cavity.

18. A connecting device according to claim 1, wherein the pin retention means comprises a toothed rail extending along the longitudinal axis of the cavity, and wherein the retention protrusion comprises a toothed rail extending along the longitudinal axis of the assembling pin.

19. A connecting device according to claim 1, wherein second connector is a hinge base, and the first connector is a hinge arm, the hinge base comprising a first and a second section, the first section being hingedly attached to the second section, the first section of the hinge base adapted for connection to a door frame or a cabinet frame, the second section of the hinge base comprising the axial cavity, and the hinge arm being adapted for connection to a door or cabinet door.

20. A connecting device according to claim 1, wherein the locking means is hingedly mounted onto the second connector with a hinge axis, comprises a handle and a push part, the push part being positioned off-axis with respect to the hinge axis of the handle, and positioned such that in the first position the push part biases the blocking means in the first state, and in the second position the push part allows movement of the blocking means out of the first position to the second position.
